(19) United States
(12) Patent Application Publication
(10) Pub. No.: US 2024/0158279 A1
(43) Pub. Date: May 16, 2024

(54) MICROCRYSTALLINE GLASS, MANUFACTURING METHOD THEREFOR AND USE THEREOF

(71) Applicant: CHONGQING AUREAVIA HI-TECH GLASS CO., LTD, Chongqing (CN)

(72) Inventors: Hao HUANG, Chongqing (CN); Yubo WANG, Chongqing (CN); Shuang DENG, Chongqing (CN); Baoquan TAN, Chongqing (CN); Wei HU, Chongqing (CN)

(73) Assignee: CHONGQING AUREAVIA HI-TECH GLASS CO., LTD, Chongqing (CN)

(21) Appl. No.: 18/423,343

(22) Filed: Jan. 26, 2024

Related U.S. Application Data
(63) Continuation-in-part of application No. PCT/CN2022/109031, filed on Jul. 29, 2022.

(30) Foreign Application Priority Data
Jul. 29, 2021 (CN) 202110866102.1

(51) Int. Cl. C03B 32/02; C03C 3/097

(52) U.S. Cl. CPC C03B 32/02; C03C 3/097

(57) ABSTRACT

A method for manufacturing a microcrystalline glass, the microcrystalline glass manufactured according to the method, and a use thereof are provided. The method includes: (1) nucleation of a raw glass sheet, followed by primary crystallization, where: the primary crystallization temperature is x₁, the primary crystallization time is t, and the primary crystallization temperature x₁ and the primary crystallization time t satisfy the following conditions: first, −a×t+652≤x₁≤−a×t+667, where a is a constant, 0.1≤a≤0.25, and tis 10 to 300 min; and second, y₁=0.0029x₁+b, where y₁ is the glass density after primary crystallization, and 2.440 g/cm³≤y₁≤2.490 g/cm³, b is a constant, and 0.55≤b≤0.60; and (2) secondary crystallization of the glass sheet which has been subject to primary crystallization.

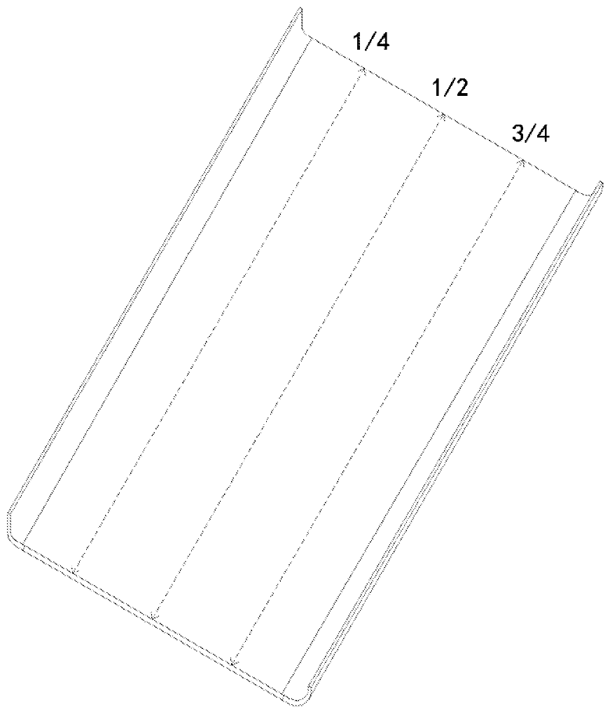

### CROSS REFERENCE TO THE RELATED APPLICATIONS

This application is a continuation-in-part application of International Application No. PCT/CN2022/109031, filed on Jul. 29, 2022, which is based upon and claims priority to Chinese Patent Application No. 202110866102.1, filed on Jul. 29, 2021, the entire contents of which are incorporated herein by reference.

### TECHNICAL FIELD

The present disclosure belongs to the field of glass manufacturing, and in particular relates to a microcrystalline glass, a manufacturing method therefor and a use thereof.

### BACKGROUND

As the information age approaches, the portability and ease of operation of smart devices become particularly important, thereby making mobile phones the most promising smart terminal device today. More and more new materials are used in the design and production for smartphones, and the cover glass always participates therein. The cover glass of mobile phone, which enters a new 3D era through the 2.5D era from 2D, not only makes the appearance of mobile phones more exquisite, but also greatly enhances the sense of touch experience for the user groups of mobile phone.

Glass becomes the best choice for screen cover because of its excellent mechanical properties and excellent light transmission performance. However, people are no longer satisfied with the traditional cover made of glass, and thus the microcrystalline glass emerges as the new development direction of cover glass. New materials bring not only new experiences, but also new challenges.

For cover glass with specific shapes (such as with curved edges), secondary heating crystallization is often required, and during the molding process of secondary crystallization, microcrystalline glass is prone to irregular deformation, resulting in lower yields and material waste.

How to control the deformation quantity of microcrystalline glass manufactured by the secondary crystallization technology is a pressing technical problem to be solved in this field.

### SUMMARY

With regard to the deficiencies of the prior art, the first objective of the present disclosure is to provide a method for manufacturing microcrystalline glass, wherein the method comprises the steps of:
(1) performing nucleation on a raw glass sheet, followed by primary crystallization, wherein a primary crystallization temperature is x₁, and a primary crystallization duration is t; and
the primary crystallization temperature x₁ and the primary crystallization duration t can meet the following conditions:

−a×t+652≤x₁≤−a×t+667, \textcircled{1}
where a is a constant, and 0.1≤a≤0.25; t is 10-300 min; and the unit of crystallization temperature x₁ is ° C.; and

y₁=0.0029x₁+b, \textcircled{2}
where y₁ is the glass density after primary crystallization, and 2.440 g/cm³≤y₁≤2.490 g/cm³,
b is a constant, and 0.55<b<0.60; and
(2) performing secondary crystallization on the raw glass sheet which has been subjected to primary crystallization.

The present disclosure controls the temperature and duration of the primary crystallization for the raw glass sheet that needs to be subjected to secondary crystallization, so as to obtain the desired types of crystal phase and crystal growth rate. Therefore, the density y₁ after primary crystallization meets 2.440 g/cm³≤y₁≤2.490 g/cm³, which closes to the density after secondary crystallization, such that the deformation rate caused by secondary crystallization is reduced and product yield is improved.

The presumed principle is that when the glass reaches the corresponding density after primary crystallization, the crystal growth inside the glass goes into a hysteresis phase with a relatively slow rate, which has a macroscopic manifestation that the glass does not expand significantly. If the density after primary crystallization is less than 2.440 g/cm³, the various crystalline phases in the glass have not been fully grown and transformed, and then after secondary crystallization, it will lead to an excessive deformation rate of the microcrystalline glass. If the density after primary crystallization is greater than 2.490 g/cm³, the crystalline phases in the glass have grown and transformed completely, and then after the secondary crystallization, it will lead to excessive growth of the crystalline phases. In this case, the deformation rate of the glass will be reduced, but the optical properties such as transmittance of the glass will be deteriorated.

It is understood that the raw glass sheets can be obtained from raw glass materials after melting, molding, and cold processing, wherein the specific preparation process typically, but not limiting, comprises weighing and mixing of the glass raw materials; melting and forming of the glass, wherein forming methods comprise but are not limited to float glass process, overflow, recycle flattening, and pouring, etc.; and annealing of the formed glass slabs and then performing cold processing to obtain the raw glass sheets of the same size.

As a preferred technical solution, the primary crystallization duration t is of 10-300 min (e.g. 25 min, 40 min, 55 min, 70 min, 95 min, 110 min, 135 min, 155 min, 195 min, 210 min, 240 min, 270 min, or 290 min, etc.), preferably 50-200 min, preferably 80-150 min, and preferably 90-120 min; the density of the glass after the primary crystallization meets 2.447 g/cm³≤y₁≤2.455 g/cm³, preferably 2.455 g/cm³≤y₁≤2.460 g/cm³, preferably 2.460 g/cm³≤y₁≤2.481 g/cm³, and preferably 2.481 g/cm³≤y₁≤2.490 g/cm³.

The glass density after primary crystallization meets 2.440 g/cm³≤y₁≤2.455 g/cm³ to further achieve the effect of controlling the deformation rate of glass after secondary crystallization at 1.2%˜1.8%; the glass density after primary crystallization meets 2.455 g/cm³≤y₁≤2.460 g/cm³ to further achieve the effect of controlling the deformation rate of glass after secondary crystallization at 1.0%˜1.2%; the glass density after primary crystallization meets 2.460 g/cm³≤y₁≤2.481 g/cm³ to further achieve the effect of controlling the deformation rate of glass after secondary crystallization at 0%˜1.0%; and the glass density after primary crystallization meets 2.481 g/cm³≤y₁≤2.490 g/cm³ to further achieve the effect of controlling the deformation rate of glass after secondary crystallization at 0.0%˜0.5%.

As a preferred technical solution, the nucleation temperature is of 520-580° C. (e.g., 525° C., 530° C., 535° C., 540° C., 545° C., 550° C., 560° C., 565° C., 570° C., or 575° C., etc.), preferably 545-575° C., preferably 550-570° C.; preferably, the nucleation duration is of 180-360 min (e.g., 190 min, 195 min, 205 min, 225 min, 240 min, 245 min, 260 min, 280 min, 300 min, 310 min, 320 min, or 330 min, etc.), preferably 200-280 min, preferably 220-250 min.

A suitable nucleation temperature can achieve an effect of uniform nucleation.

As a preferred technical solution, the process of secondary crystallization comprises, in sequence, a heating stage, a thermoforming stage, and a cooling stage.

The process of the secondary crystallization is staged to control the temperature of each stage precisely, thereby reducing or even eliminating the impact on material properties due to the instability of processing equipment and further improving the consistency of the finished product to enhance production yield.

As a preferred technical solution, the heating stage is to raise the temperature from room temperature at a rate of 10-60° C./min to a first target temperature; preferably the heating rate is of 20-50° C./min, preferably 30-40° C./min; and the first target temperature is of 650-750° C., and preferably the first target temperature is of 670-730° C., preferably 680-710° C.

As a preferred technical solution, the thermoforming stage is to raise the temperature from the first target temperature to a second target temperature; and the heating rate is 15-50° C./min, preferably 20-40° C./min, and preferably 30-40° C./min.

The second target temperature is of 680-800° C., preferably 700-780° C., preferably 720-750° C., and preferably 730-740° C.

As a preferred technical solution, the cooling stage is to cool down from the second target temperature to room temperature at a rate of 30-50° C./min, preferably at a cooling rate of 35-45° C./min, and preferably 38-40° C./min.

A suitable temperature change curve can reduce the impact of processing equipment on the glass, on the one hand, to prevent the glass from breaking due to sudden cold and sudden heat, and on the other hand, to prevent the increased working hours and low production efficiency due to a too slow heating or cooling rate. In addition, by controlling the temperature change curve, the optical properties of the glass can also be improved.

As a preferred technical solution, the raw glass sheet is lithium-aluminum-silicon glass.

Preferably, the raw glass sheet contains, in mol %, the following components:

| | |
|---|---|
| Al₂O₃ | 3~7 |
| ZrO₂ | 0.5~5 |
| Li₂O | 10~25 |
| Na₂O | 0.5~5 |
| P₂O₅ | 0.5~2 |
| B₂O₃ | 0.1~2 |
| SiO₂ | 65~72. |

As a preferred technical solution, the Al₂O₃ content in the raw glass sheet is of 4-6 mol %, preferably 4.5-5.5 mol %.

As a preferred technical solution, the ZrO₂ content in the raw glass sheet is of 1-4 mol %, preferably 2.5-3.5 mol %.

As a preferred technical solution, the Li₂O content in the raw glass sheet is of 14-20 mol %, preferably 16-19 mol %, and preferably 17-18 mol %.

As a preferred technical solution, the Na₂O content in the raw glass sheet is of 0.7-3.2 mol %, preferably 1.0-2.5 mol %.

As a preferred technical solution, the P₂O₅ content in the raw glass sheet is of 0.8-1.5 mol %, preferably 1-1.3 mol %.

As a preferred technical solution, the B₂O₃ content in the raw glass sheet is of 0.5-1.5 mol %, preferably 0.8-1.2 mol %.

As a preferred technical solution, the SiO₂ content in the raw glass sheet is of 67-71 mol %, preferably 68-70 mol %.

The second objective of the present disclosure is to provide a microcrystalline glass obtained by a method as described in the first objective.

The third objective of the present disclosure is to provide a use of microcrystalline glass manufactured by the method as described in the first objective, wherein the microcrystalline glass is used as any one of a mobile phone cover, a watch cover, a tablet computer cover, or an automobile display cover.

Compared with the prior art, the present disclosure has at least the following beneficial effects.

The present disclosure controls the temperature and duration of the primary crystallization of the raw glass sheet that needs to be subjected to the secondary crystallization, such that the density y₁ after primary crystallization meets 2.440 g/cm³≤y₁≤2.490 g/cm³, which closes to the density after secondary crystallization, and thus the deformation degree during secondary crystallization is reduced. Moreover, the manufactured glass has a good transmittance, thereby improving product yield.

### BRIEF DESCRIPTION OF THE DRAWINGS

The FIGURE is a schematic view of the measured position when measuring the change in glass size after secondary crystallization.

### DETAILED DESCRIPTION OF THE EMBODIMENTS

The technical solutions of the present disclosure are further described below by means of specific embodiments.

It should be apparent to those skilled in the art that the embodiments are merely helpful in understanding the present disclosure and should not be considered as a specific limitation to the present disclosure.

### Example 1

A microcrystalline glass was manufactured by the following method.
(1) The raw glass materials were weighed and mixed according to the following glass formula to obtain the raw-material mixture; and
the raw materials, in mol %, contained the following components:

| | |
|---|---|
| Al₂O₃ | 5 |
| ZrO₂ | 2.7 |
| Li₂O | 14.9 |
| Na₂O | 2.1 |
| P₂O₅ | 1.6 |
| B₂O₃ | 0.75 |
| SiO₂ | balance. |

(2) The raw-material mixture was molded and cooled to obtain the raw glass sheet, wherein the molding method was to melt at 1650° C. for 5 h and then cast in the mold preheated to 200° C., and the cooling method was to anneal at 580° C. for 24 h and then reduce to room temperature with the annealing furnace; and the size of the glass sheet is 159×74×0.60 mm.
(3) The raw glass sheet was subjected to nucleation, wherein the nucleation temperature was 555° C. and the nucleation duration was 280 min; then the primary crystallization was performed, wherein the primary crystallization temperature is 645° C. and the primary crystallization duration is 100 min.
(4) The raw glass sheet after the primary crystallization was subjected to the secondary crystallization, to obtain the microcrystalline glass; and the secondary crystallization process was carried out according to the following temperature changing procedure: rising from room temperature at a rate of 20° C./min to 700° C., rising from 700° C. to 800° C. at a rate of 25° C./min, and falling from 800° C. to room temperature at a rate of 20° C./min.

### Example 2

The difference from Example 1 was that the primary crystallization temperature of step (3) was 640° C. and the primary crystallization duration was 100 min.

### Example 3

The difference from Example 1 was that the primary crystallization temperature of step (3) was 635° C. and the primary crystallization duration was 100 min.

### Example 4

The difference from Example 1 was that the primary crystallization temperature of step (3) was 650° C. and the primary crystallization duration was 100 min.

### Example 5

The difference from Example 1 was that the primary crystallization temperature of step (3) was 637° C. and the primary crystallization duration was 90 min.

### Example 6

The difference from Example 1 was that the primary crystallization temperature of step (3) was 642° C. and the primary crystallization duration was 90 min.

### Example 7

The difference from Example 1 was that the primary crystallization temperature of step (3) was 647° C. and the primary crystallization duration was 90 min.

### Example 8

The difference from Example 1 was that the primary crystallization temperature of step (3) was 652° C. and the primary crystallization duration was 90 min.

### Example 9

The difference from Example 1 was that the primary crystallization temperature of step (3) was 635° C. and the primary crystallization duration was 120 min.

### Example 10

The difference from Example 1 was that the primary crystallization temperature of step (3) was 640° C. and the primary crystallization duration was 120 min.

### Example 11

The difference from Example 1 was that the primary crystallization temperature of step (3) was 655° C. and the primary crystallization duration was 100 min.

### Example 12

The difference from Example 1 was that the primary crystallization temperature of step (3) was 636° C. and the primary crystallization duration was 300 min.

### Example 13

The difference from Example 1 was that the primary crystallization temperature of step (3) was 650° C. and the primary crystallization duration was 10 min.

### Example 14

The difference from Example 1 was that the glass formulation of step (1) was as follows, wherein
the raw materials, in mol %, contained the following components:

| | |
|---|---|
| Al₂O₃ | 7.0 |
| ZrO₂ | 0.5 |
| Li₂O | 25.0 |
| Na₂O | 0.5 |
| P₂O₅ | 2.0 |
| B₂O₃ | 2.0 |
| SiO₂ | balance. |

### Example 15

The difference from Example 1 was that the glass formulation of step (1) was as follows, wherein
the raw materials, in mol %, contained the following components:

| | |
|---|---|
| Al₂O₃ | 3.0 |
| ZrO₂ | 5.0 |
| Li₂O | 10 |
| Na₂O | 5.0 |
| P₂O₅ | 0.5 |
| B₂O₃ | 0.1 |
| SiO₂ | balance. |

### Example 16

The difference from Example 1 was that the nucleation temperature of step (3) was 520° C. and the nucleation duration was 360 min; and
in step (4), the temperature was increased from room temperature to 650° C. at a rate of 10° C./min, increased from 650° C. to 680° C. at a rate of 15° C./min, and decreased from 680° C. to room temperature at a rate of 10° C./min.

### Example 17

The difference from Example 1 was that the nucleation temperature of step (3) was 580° C. and the nucleation duration was 180 min; and
in step (4), the temperature was increased from room temperature to 750° C. at a rate of 60° C./min, increased from 750° C. to 850° C. at a rate of 50° C./min, and decreased from 850° C. to room temperature at a rate of 50° C./min.

### Comparative Example 1

The difference from Example 1 was that the primary crystallization temperature of step (3) was 630° C. and the primary crystallization duration was 150 min.

### Comparative Example 2

The difference from Example 1 was that the primary crystallization temperature of step (3) was 675° C. and the primary crystallization duration was 100 min.

### Comparative Example 3

The difference from Example 1 was that the primary crystallization temperature of step (3) was 635° C. and the primary crystallization duration was 50 min.

Performance Test
(1) Density measurement: the measurement method was as follows: the glass sheet to be measured was soaked in a mixed solution including ethanol and pure water at a ratio of 1:1 for 30 min, and then placed in the ultrasonic cleaning machine (XDQ 5090ST, Dongguan Xingdaqiang Ultrasonic Equipment Co., Ltd.) for 10 min; a dust-free cloth was used to wipe up the surface liquid; and a densitometer (ELECTRONIC DEN DENSIMEETER SD-200L, Japan) was used to measure the density, so as to measure the density after primary crystallization and the density after secondary crystallization.
(2) Dimensional change: the test method was as follows: the two-dimensional size of the glass after the secondary crystallization process was measured by using a two-dimensional measuring instrument (MY-YXCL-4030 (±0.01 mm)). The test method was as follows: three sets of data were measured at positions of ¼, ½, and ¾ of the long side (The FIGURE shows a schematic view of the measured positions in the measurement method), wherein 30 data were obtained from ten tested sheets. The maximum value (Lₘₐₓ, mm) and the minimum value (Lₘᵢₙ, mm) among the 30 data were selected to calculate the difference between the maximum value and the minimum value, which was recorded as dimensional change y₂ (mm). The deformation rate was then calculated, which was equal to y₂/(Lₘₐₓ+Lₘᵢₙ)/2×100%, where the deformation rate represented the concentration degree of the dimensional change of the batch of glass after the secondary crystallization. The larger deformation rate represented the larger dimensional change, and the smaller deformation rate represented the smaller dimensional change.
(3) Light transmittance: the test method was as follows. The glass sheet after crystallization was cleaned in the ultrasonic cleaning machine, wherein the cleaning condition comprised a cleaning duration of 5-10 min, the used cleaning agent being the common detergent diluted by 10 times, a cleaning temperature of 45° C.-65° C., and a cleaning frequency of 20 KHZ-40 KHZ. The haze meter was used to test the transmittance of microcrystalline glass at different wavelengths according to the standard “GB/T 7962.12-2010 Colorless Optical Glass Test Method Part 12: Inter-spectral Transmission Ratio”, and the haze meter used in the present disclosure was spectrocolorimeter CM-3600A, Konica Minolta, Japan.

The relevant parameters and test results of primary crystallization are shown in Table 1.

TABLE 1
Relevant parameters and test results of primary crystallization

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| primary crystallization | 645 | 640 | 635 | 650 | 637 | 642 | 647 | 652 | 635 | 640 |
| temperature/° C. | | | | | | | | | | |
| primary crystallization | 100 | 100 | 100 | 100 | 90 | 90 | 90 | 90 | 120 | 120 |
| duration/min | | | | | | | | | | |
| density after primary | 2.461 | 2.452 | 2.440 | 2.483 | 2.442 | 2.458 | 2.462 | 2.484 | 2.441 | 2.460 |
| crystallization/g/cm³ | | | | | | | | | | |
| whether the condition | Yes | Yes | Yes | Yes | Yes | Yes | Yes | Yes | Yes | Yes |
| I is met | | | | | | | | | | |
| whether the condition | Yes | Yes | Yes | Yes | Yes | Yes | Yes | Yes | Yes | Yes |
| II is met | | | | | | | | | | |
| dimensional change y₂/mm | 0.109 | 0.161 | 0.238 | 0.054 | 0.231 | 0.149 | 0.105 | 0.046 | 0.234 | 0.111 |
| deformation rate/% | 0.98 | 1.22 | 1.48 | 0.40 | 1.45 | 1.09 | 0.67 | 0.38 | 1.47 | 1.01 |
| light transmittance/% | 90.15 | 89.70 | 89.34 | 90.61 | 89.47 | 89.73 | 90.19 | 90.72 | 89.41 | 90.13 |

| | Example | Example | Example | Example | Example | Example | Example | Comparative | Comparative | Comparative |
|---|---|---|---|---|---|---|---|---|---|---|
| | 11 | 12 | 13 | 14 | 15 | 16 | 17 | Example 1 | Example 2 | Example 3 |
| primary crystallization | 655 | 636 | 650 | 645 | 645 | 645 | 645 | 630 | 675 | 635 |
| temperature/% | | | | | | | | | | |
| primary crystallization | 100 | 300 | 10 | 100 | 100 | 100 | 100 | 100 | 100 | 50 |
| duration/min | | | | | | | | | | |
| density after primary | 2.486 | 2.442 | 2.449 | 2.461 | 2.462 | 2.461 | 2.461 | 2.418 | 2.495 | 2.438 |
| crystallization/g/cm³ | | | | | | | | | | |
| whether the condition | Yes | Yes | Yes | Yes | Yes | Yes | Yes | Yes | No | No |
| I is met | | | | | | | | | | |
| whether the condition | Yes | Yes | Yes | Yes | Yes | Yes | Yes | No | No | No |
| II is met | | | | | | | | | | |
| dimensional change/ | 0.036 | 0.230 | 0.195 | 0.111 | 0.107 | 0.109 | 0.109 | 0.358 | 0.053 | 0.242 |
| mm | | | | | | | | | | |
| deformation rate/% | 0.34 | 1.44 | 1.24 | 0.99 | 0.97 | 0.98 | 0.98 | 1.88 | 0.39 | 1.53 |
| light transmittance/% | 90.74 | 89.45 | 89.69 | 90.13 | 90.18 | 89.95 | 90.19 | 86.11 | 87.85 | 86.21 |

According to Table 1, it can be seen that
both the temperature X₁ and the duration t of the primary crystallization implemented in Examples 1-17 meet
condition I: −a×t+652≤x₁≤−a×t+667, where a is a constant, and 0.1≤a≤0.25; and t is 10-300 min, and the crystallization temperature x₁ is in ° C.; and
condition II: y₁=0.0029x₁+b, where y₁ is the glass density after primary crystallization, and 2.440 g/cm³≤y₁≤2.490 g/cm³; and b is a constant, and 0.55<b<0.60. The deformation rate of the produced microcrystalline glass is less than 1.5%, and the light transmittance is higher than 89%, wherein within the limited range of density of the glass after primary crystallization, the deformation rate of the glass after secondary crystallization gradually decreases as the density increases, and the light transmittance also increases correspondingly.

In the Comparative Example 1, the temperature and duration of primary crystallization meet the condition I, but the temperature and density after primary crystallization do not meet the condition II. It can be seen that, after secondary crystallization, the deformation rate of the glass increases to 1.88% and the light transmittance is poorer.

In the Comparative Example 2, the temperature and duration of primary crystallization do not meet conditions I and II, where the density after primary crystallization exceeds 2.490 g/cm³. It can be seen that the light transmittance is deteriorated, although a relatively small deformation rate can be obtained.

In the Comparative Example 3, the temperature and duration of primary crystallization do not satisfy conditions I and II. It can be seen that after the secondary crystallization, the deformation rate of the glass increases to 1.53% and the light transmittance is poorer.

The above-described embodiments are only a part of the embodiments of the present disclosure, and not all of them. The detailed description of embodiments of the present disclosure is not intended to limit the scope of the present disclosure for which protection is claimed, but merely denote selected embodiments of the present disclosure. Based on the embodiments of the present disclosure, all other embodiments obtained by those skilled in the art without creative effort shall fall within the protection scope of the present disclosure.

What is claimed is:

1. A method for manufacturing a microcrystalline glass, wherein the method comprises steps of
(1) performing nucleation on a raw glass sheet, followed by primary crystallization, wherein a primary crystallization temperature is x₁, and a primary crystallization duration is t, wherein
the primary crystallization temperature x₁ and the primary crystallization duration t satisfy following conditions:
−a×t+652≤x₁≤−a×t+667, I
where a is a constant, and 0.1≤a≤0.25; and t is 10-300 min, and the primary crystallization temperature x₁ has a unit of ° C.; and
y₁=0.0029x₁+b, II
where y₁ is a glass density after the primary crystallization, and 2.440 g/cm³≤y₁≤2.490 g/cm³; and
b is a constant, and 0.55<b<0.60; and
(2) performing secondary crystallization on the raw glass sheet after the primary crystallization.

2. The method according to claim 1, wherein the glass density after the primary crystallization meets 2.447 g/cm³≤y₁≤2.490 g/cm³.

3. The method according to claim 1, wherein a nucleation temperature is of 520-580° C.; and a nucleation duration is of 180-360 min.

4. The method according to claim 1, wherein a process of the secondary crystallization comprises, in sequence, a heating stage, a thermoforming stage, and a cooling stage.

5. The method according to claim 4, wherein the heating stage is to raise a temperature from a room temperature at a rate of 10-60° C./min to a first target temperature, wherein the first target temperature is of 650-750° C.

6. The method according to claim 5, wherein a heating rate of the heating stage is of 20-50° C./min.

7. The method according to claim 4, wherein the thermoforming stage is to raise a temperature from the first target temperature to a second target temperature, wherein a heating rate is 15-50° C./min and the second target temperature is of 680-850° C.

8. The method according to claim 4, wherein the cooling stage is to cool down from a second target temperature to a room temperature at a rate of 10-50° C./min.

9. The method according to claim 1, wherein the raw glass sheet is a lithium-aluminum-silicon glass.

10. A microcrystalline glass, wherein the microcrystalline glass is manufactured by the method according to claim 1.

11. A use method of the microcrystalline glass manufactured by the method according to claim 1, wherein the microcrystalline glass is configured as any one selected from the group consisting of a cell phone cover, a watch cover, a tablet computer cover, and an automobile display cover.

12. The method according to claim 2, wherein the glass density after the primary crystallization meets 2.455 g/cm³≤y₁≤2.490 g/cm³.

13. The method according to claim 2, wherein the glass density after the primary crystallization meets 2.460 g/cm³≤y₁≤2.490 g/cm³.

14. The method according to claim 2, wherein the glass density after the primary crystallization meets 2.481 g/cm³≤y₁≤2.490 g/cm³.

15. The method according to claim 3, wherein the nucleation temperature is of 545-575° C.

16. The method according to claim 3, wherein the nucleation temperature is of 550-570° C.

17. The method according to claim 3, wherein the nucleation duration is of 200-280 min.

18. The method according to claim 3, wherein the nucleation duration is of 220-250 min.

19. The method according to claim 6, wherein the heating rate of the heating stage is of 30-40° C./min.

20. The method according to claim 9, wherein the raw glass sheet contains, in mol %, following components:

| | |
|---|---|
| Al₂O₃ | 3~7 |
| ZrO₂ | 0.5~5 |
| Li₂O | 10~25 |
| Na₂O | 0.5~5 |
| P₂O₅ | 0.5~2 |
| B₂O₃ | 0.1~2 |
| SiO₂ | 65~72. |
